(19) United States
(12) Patent Application Publication
(10) Pub. No.: US 2010/0008552 A1
(43) Pub. Date: Jan. 14, 2010

(54) APPARATUS FOR DISTINGUISHING LIVING BODY FINGERPRINT AND METHOD THEREOF

(75) Inventors: Yo-shik SHIN, Seoul (KR); Geum-yong KIM, Seoul (KR); Ji-Ho LEE, Seoul (KR)

Correspondence Address: STEIN MCEWEN, LLP, 1400 EYE STREET, NW, SUITE 300, WASHINGTON, DC, 20005, US

(73) Assignee: Union Community Co., Ltd., Seoul (KR)

(21) Appl. No.: 12/418,707

(22) Filed: Apr. 6, 2009

(30) Foreign Application Priority Data
Jul. 14, 2008 (KR) 2008-67903

(51) Int. Cl. G06K 9/00

(52) U.S. Cl. 382/124

(57) ABSTRACT

An apparatus for distinguishing living body fingerprint from artificial fingerprint and a method thereof are provided. A living body recognition unit determines whether fingerprint in question is living body fingerprint or not, based on the unique color of the living body fingerprint and a change of the fingerprint color which is caused due to a change of contact pressure when the living body fingerprint is contacted with the fingerprint input window. A fingerprint recognition apparatus computes color information from the fingerprint image acquired by the color image sensor, and color change information based on the change of contact pressure, and determines whether the fingerprint in question is the living body fingerprint by determining whether or not the computed color information meets a reference color range and/or if the color change information meets a reference condition.

### CROSS-REFERENCE TO RELATED APPLICATIONS

This application claims priority under 35 U.S.C. §119(a) from Korean Patent Application No. 10-2008-0067903, filed on Jul. 14, 2008, in the Korean Intellectual Property Office, the disclosure of which is incorporated herein by reference in its entirety.

### BACKGROUND OF THE INVENTION

1. Field of the Invention

The present invention relates to an apparatus for distinguishing living body fingerprint and a method thereof, capable of determining whether or not fingerprint in an optically acquired fingerprint image is the living body fingerprint, based on an intrinsic color of a living body fingerprint and a change of fingerprint color caused due to a change of pressure when the fingertip is contacted with a fingerprint input window.

2. Description of the Related Art

Biometric information has been used in a wide variety of systems that require verification of individuals due to high discriminability and invariability. Among biometric information-based recognition schemes, fingerprint recognition has gained more attention and popularity than the others due to convenience and easy operation it provides.

Fingerprint recognition is currently used in a wide range of applications that require authentication processes, such as access control, e-business, financial transaction, or personal computer (PC) or company's Intranet security. However, despite the high level of accuracy, economics, and convenience of authentication it provides, the fingerprint recognition suffers the shortcoming of false authentication by fingerprint forgery. Therefore, a variety of algorithms are developed to prevent and improve losses caused by fingerprint forgery and false authentication.

General ways to forge a fingerprint is to apply or coat transparent liquid such as water or oil on a paper sheet or a film printed with a fingerprint image thereon, or to use the substances such as silicone or rubber which are closest to the human skin structure.

One could put artificial fingerprint on his fingertip and attempt to circumvent the authentication system with this, and in this case, the forged fingerprint can hardly be distinguished by the known fingerprint distinguishing technologies such as temperature detection, pulse detection, pressure detection, blood flood detection, or sweat gland detection.

### SUMMARY OF THE INVENTION

Accordingly, the present invention has been made keeping in mind the above problems occurring in the prior art, and an object of the present invention is to provide an apparatus for distinguishing living body fingerprint and a method thereof, capable of determining whether or not fingerprint in an optically acquired fingerprint image is the living body fingerprint, based on an intrinsic color of a living body fingerprint and a change of fingerprint color caused due to a change of pressure when the fingertip is contacted with a fingerprint input window.

In order to accomplish the above object, the present invention provides a method of distinguishing a living body fingerprint, which includes irradiating a light toward a prism and acquiring a color fingerprint image of a contacting fingerprint contacted with a fingerprint input window of the prism, computing color change information regarding a change of color information of the color fingerprint image at the first and second time points, the contacting fingerprint being in contact with the fingerprint input window at the first and second time points, and determining the contacting fingerprint to be the living body fingerprint, if the color change information meets a reference condition regarding a change of color of the living body fingerprint which is caused in accordance with a change of a contact pressure.

The color information may include lightness levels of red, green and blue components, and may preferably be extracted from a ridge area of the color fingerprint image. Further, one of the first and second time points corresponds to a time point when acquiring of the color fingerprint image begins according to the contact of the fingerprint with the fingerprint input window.

The reference condition corresponds to at least one of ΔG>ΔR, ΔG>ΔB and R(1)−G(1)>R(2)−G(2), where R(1) and G(1) correspond to lightness of red and green components of the color fingerprint image at the first time point, R(2) and G(2) correspond to lightness of red and green components of the color fingerprint image at the second time point, ΔR=R(2)−R(1), ΔG=G(2)−G(1), and ΔB is a difference of lightness of blue component of the color fingerprint image at the second and first time points.

The method according to an exemplary embodiment of the present invention may further include determining whether or not color information at one time point of the plural time points comprising the first and second time points, or an average of color information at two or more time points of the plural time points comprising the first and second time points, falls to a reference color range, and if not, determining the contacting fingerprint to be artificial fingerprint. The above step can precede the computing of the color change information. Accordingly, if the above step determines the fingerprint to be the artificial one, the computing of the color change information and the determining of the living body fingerprint may be omitted.

The reference color range may span from a color acquired from the living body fingerprint at one time point of the plural time points comprising the first and second time points to a color added with predetermined margin of the acquired color, or from an average of colors acquired from the living body fingerprint at two or more time points of the plural time points comprising the first and second time points to a color with a predetermined margin of the average of colors.

According to another exemplary embodiment of the present invention, the method of distinguishing living body fingerprint may not necessarily include the determining of the living body fingerprint based on the color change information explained above. In other words, it is possible to determine the fingerprint to be the living body fingerprint by computing color information of the acquired color fingerprint image, and determining whether or not the computed color information falls to a reference color range of the living body fingerprint. That is, the fingerprint may be determined to be the living body fingerprint if the computed color information falls to the reference color range of the living body fingerprint.

According to yet another exemplary embodiment of the present invention, an apparatus for distinguishing living body fingerprint may include an optical refractor, an optical lens system, a color image sensor and a living body recognition unit.

The color image sensor acquires a color fingerprint image from an image converged on the optical lens system, and provides the living body recognition unit with the result. The living body recognition unit computes color change information regarding a change of the color information of the color fingerprint image being acquired at a first and second time points, and determines the fingerprint to be the living body fingerprint when the color change information meets a reference condition regarding the change of color of the living body fingerprint. Herein, the fingerprint is in contact with the fingerprint input window at the first and second time points.

### BRIEF DESCRIPTION OF THE DRAWINGS

FIG. 1 is a block diagram of a living body fingerprint distinguishing apparatus according to an exemplary embodiment of the present invention;

FIGS. 2(a) to 2(g) illustrate fingerprint images captured from a living body fingerprint and an artificial fingerprint;

FIG. 3 is a graphical representation of the color structures of fingerprint images captured from a living body fingerprint and an artificial fingerprint;

FIG. 4 is a graphical representation illustrating a change of color of a living body fingerprint in accordance with a change of contact pressure; and

FIG. 5 is a flowchart illustrating a method of distinguishing a living body fingerprint according to an exemplary embodiment of the present invention.

### DESCRIPTION OF THE PREFERRED EMBODIMENTS

The preferred embodiments of the present invention will be explained in greater detail below with reference to the accompanied drawings.

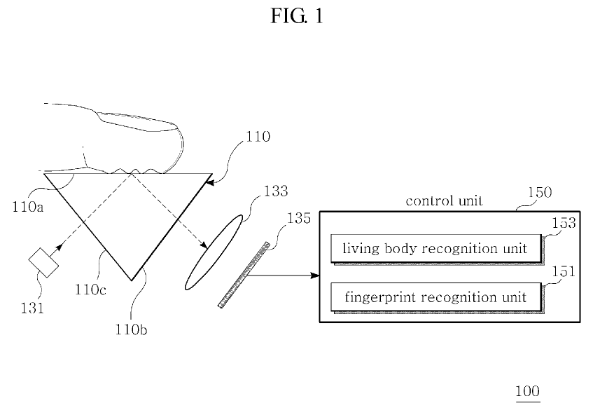

FIG. 1 is a block diagram of a living body fingerprint distinguishing apparatus according to an exemplary embodiment of the present invention. Particularly, FIG. 1 illustrates an example where the living body fingerprint distinguishing apparatus 100 is implemented as a fingerprint recognition apparatus.

The living body fingerprint distinguishing apparatus 100 of FIG. 1 operates to capture a fingerprint image from a user's fingerprint (or finger), determine whether the captured fingerprint corresponds to a living body fingerprint or artificial one, and enroll the user fingerprint and/or verify the user's identity based on the result of determination.

The living body fingerprint distinguishing apparatus 100 acquires fingerprint images optically, using an optical refractor. However, the living body fingerprint distinguishing apparatus 100 according to an exemplary embodiment of the present invention is not limited to certain manner of optical imaging such as diffusive or absorption type, and thus may be implemented on any type of optical fingerprint image capturing device which uses the light reflected or diffused from the user fingerprint.

The living body fingerprint distinguishing apparatus 100 of FIG. 1 includes a prism 110 having a fingerprint input window 110 formed on one side, a light source 131 to emit a ray of light toward the prism 110 for acquiring a fingerprint image, a color image sensor 135, an optical lens system 133 to focus the fingerprint image on the color image sensor 135, and a control unit 150.

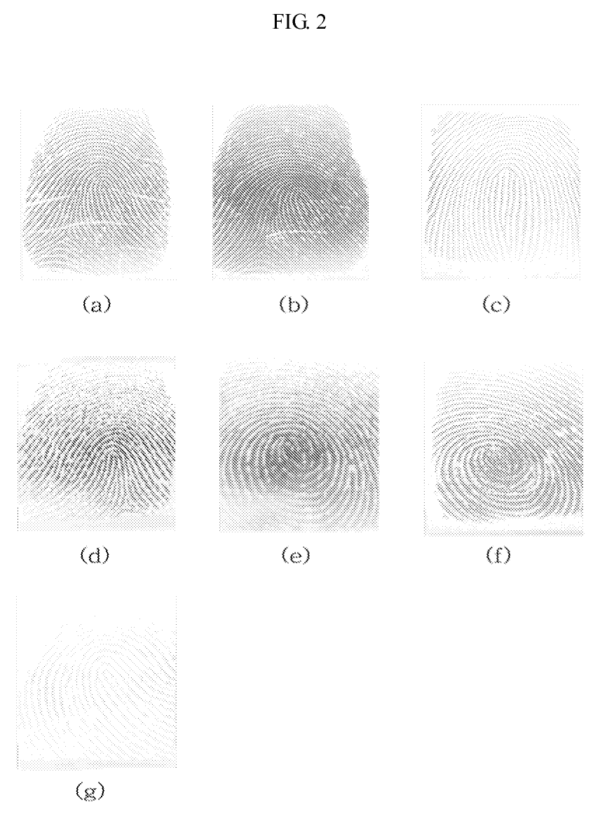

The prism 110 includes a fingerprint input window 110a on which fingerprint is contacted, and a light emitting surface 110b through which the light (that is, fingerprint image) reflected or diffused from the fingerprint input window 110a is emerged. As shown in FIG. 2, the prism 110 may be formed to have three faces (triangular shape) as well as four faces (trapezoidal shape) when viewed in section (or when an optically unusable face is excluded), or alternatively, yet broader sense of the prism 110, such as a light refractor, may be used instead.

The light source 131 uses a white light which includes three primary colors, that is, red, green and blue. The light source 131 may be placed in various positions depending on the manner of fingerprint recognition and the shape of the prism 110.

The color image sensor 135 converts the light, which is passed through the prism 110 and the optical lens system 133, into an electrical signal, which is a digital color fingerprint image and outputs this to the control unit 150. The color fingerprint image may include information about the fingerprint's color, lightness or pattern.

Accordingly, the light emitted from the light source 131 is entered through the light incident surface 110c of the prism 110, reflected or/and diffused from the fingerprint input window 110a with which the user's fingerprint is contacted, emerged through the light emitting surface 110b, converged by the optical lens system 133 and input to the color image sensor 135.

The control unit 150 determines whether the fingerprint currently contacted with the fingerprint input window 110a is a living body fingerprint or artificial one based on the color fingerprint image provided by the color image sensor 135, and performs fingerprint recognition process. To this end, the control unit 150 may include a fingerprint recognition unit 151 and a living body recognition unit 153.

The fingerprint recognition unit 151 may recognize the user fingerprint according to a predefined image processing algorithm or authentication algorithm.

According to an exemplary embodiment of the present invention, the fingerprint recognition unit 151 may not always perform fingerprint recognition. That is, the fingerprint recognition unit 151 may extract traits from the fingerprint image received from the color image sensor 135 and perform user recognition only upon receiving a result of determination from the living body recognition unit 153 indicating that the fingerprint is from a living body. If the fingerprint contacted with the fingerprint input window 110a is determined to be the artificial one, the fingerprint recognition unit 151 may perform a predetermined recognition reject process.

The living body recognition unit 153 determines whether the fingerprint contacting the fingerprint input window 110a is a living body fingerprint or artificial one based on the fingerprint image input through the color image sensor 135, and outputs the result of determination to the fingerprint recognition unit 151.

The living body recognition unit 153 performs the first determination based on a difference of color between the light reflected from the living body skin structure and that from an artificial fingerprint. The living body recognition unit 153 may then determine whether the fingerprint is from a living body or an artificial fingerprint, in the second determination, based on the change of color of a fingerprint image which is inevitably caused when the user places his fingerprint against the fingerprint input window 110a, incurring a change of contact pressure. The above two determination processes may not always be performed jointly. For example, each of the determination processes may be implemented independently to distinguish a living body fingerprint.

The living body recognition unit 153 may use the entirety of the color fingerprint image received from the color image sensor 135 for the determination, or alternatively, may use a portion of the color fingerprint image such as predetermined pixels in the central area.

As the image is acquired based on the white light reflected from the surface of the living body fingerprint, the acquired image reflects color information of the skin surface. When the white light at various wavelengths is entered into the living body structure, some light is absorbed in the skin structure or reflected from it depending on the inner substances such as protein, hemoglobin, melanin or water. Since the color fingerprint image is generated by converting the reflected light source, the color fingerprint image has the color information in accordance with the traits of the living body fingerprint. Human hands, especially, human fingertips are generally light pink. In other words, there are more capillary blood vessels in the fingertips than in the other skin parts, and the blood appears pink due to the presence of skin layer.

Meanwhile, the artificial fingerprint has different color information from that of the living body fingerprint.

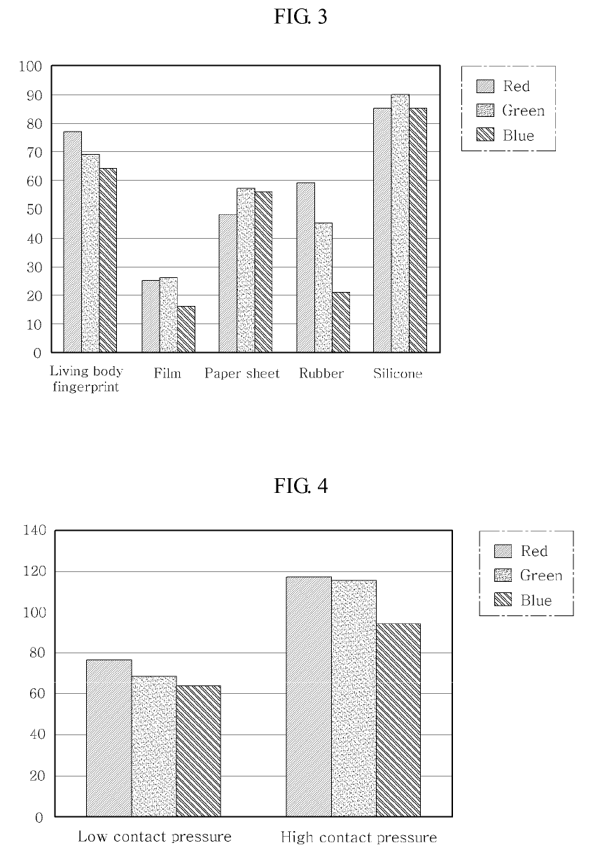

FIGS. 2(a) to 2(g) illustrate color fingerprint images captured from a living body fingerprint and an artificial fingerprint by using the color image sensor 135, and FIG. 3 is a graphical representation of the color structures of fingerprint images captured from a living body fingerprint and an artificial fingerprint. But, FIGS. 2(a) to 2(g) illustrate fingerprint images of which colors are removed. The vertical axis represents the relative brightness of the corresponding colors removed color from color images

The fingerprint images of FIGS. 2(a) to 2(g) are acquired in a ‘scattering type’, according to which the ridges of the fingerprint originally appear brighter than valleys. However, since these fingerprint images are inversed ones for a clearer distinction between ridges, valleys and background, and accordingly, the background, which is originally black, appears white, and the ridges originally in bright color appear in dark color such as blue as complementary color.

Specifically, FIGS. 2(a) and 2(b) are color fingerprint images acquired from a living body fingerprint, in which FIG. 2(a) shows the case of low contact pressure and FIG. 2(b) shows the case of high contact pressure. The terms ‘low contact pressure’ and ‘high contact pressure’ intend to represent different levels of strengths with which the fingertip is contacted with the fingerprint input window 110a, and the color of the fingerprint image varies according to the variation of the contact pressure like FIG. 3.

FIGS. 2(c), 2(d), 2(e), 2(f) and 2(g) illustrate fingerprint images acquired from the artificial fingerprints, that is, from a rubber fingerprint, a black and white fingerprint image printed on a paper sheet, a color fingerprint printed on a paper sheet, a fingerprint on a transparent silicone, and a fingerprint on a film, respectively.

Referring to FIGS. 2(a) to 2(g) and 3, the living body fingerprint has a different color from those of the artificial ones. Since all the fingerprint images have the similar ridge pattern, accuracy is not guaranteed with the conventional ways of fingerprint recognition which do not use color information for the recognition.

The graphical representation of FIG. 3 illustrates the color information of the living body fingerprint (with low contact pressure), and film, paper, rubber, and transparent silicone fingerprints.

A living body fingerprint (especially the ridge area) has the highest rate of red color, and then green. The blue color has the lowest lightness. The artificial fingerprint has different color distribution from that of the living body fingerprint. Even the transparent silicone having color distribution closest to the living body has red, green and blue in different rates and lightness levels. The present invention proposes to determine a living body fingerprint from the artificial one based on these differences.

However, certain artificial fingerprint may have the same color information as the living body fingerprint. Therefore, the living body fingerprint distinguishing device 100 further considers a change of color of a living body fingerprint which is caused due to a change of contact pressure.

When the skin structure is under pressure, that is, when there is a change of contact pressure, which is inevitable when the living body fingertip is brought into contact with the fingerprint input window 110a, capillary blood vessels underneath the fingertip are narrowed and the blood moves from the area under pressure so that the skin color changes from red to yellow. As mentioned earlier, the fingertips have more capillary blood vessels than any other skin structure and are thus more apt to change color when the pressure changes. This color change can not be observed in the artificial fingerprints using paper, film, silicone, rubber, or gelatin.

FIG. 4 is a graphical representation illustrating a change of color of a living body fingerprint in accordance with the change of contact pressure. Basically, if there is a change of contact pressure in the low contact pressure area of the living body fingerprint (that is, in the ridge area) which is reddish, rates of red and green become similar, and blue color is relatively decreased. As a result, the overall lightness increases and the area changes to bright yellowish color.

Specifically, red and green have less lightness difference in the state of having high contact pressure than in the state of having low contact pressure. This distinctive color change may be expressed as follows:

R(1)+ΔR+G(1)+ΔG+B(1)+ΔB=R(2)+G(2)+B(2) [Mathematical expression 1]

ΔG>ΔR [Mathematical expression 2]

ΔG>ΔB [Mathematical expression 3]

R(1)−G(1)>R(2)−G(2) [Mathematical expression 4]

where lightness of the color is the variable. Therefore, R(1) is the lightness of red component in the state of low contact pressure, G(1) is the lightness of green component in the state of low contact pressure, and B(1) is the lightness of blue component in the state of low contact pressure. R(2) is the lightness of red component in the state of high contact pressure, G(2) is the lightness of the green component in the state of high contact pressure, and B(2) is the lightness of the blue component in the state of high contact pressure. Also, ΔR=R(2)−R(1), ΔG=G(2)−G(1), and ΔB=B(2)−B(1). ΔR, ΔG, and ΔB are not 0.

R(1), G(1), B(1), R(2), G(2), B(2) are based on the color of ridges of the fingerprint. According to another exemplary embodiment, the color of the ridges and valleys of the entire color fingerprint image or certain selected area thereof may be used as a reference. In this case, the conditions of mathematical expressions 1 to 4, or reference color of the living body fingerprint may be varied accordingly.

The artificial fingerprint on a paper sheet, film, rubber, silicone, gelatin, or the like, does not have a change of color structure as is observed in the living body fingerprint when the contact pressure changes. Accordingly, the living body fingerprint distinguishing apparatus 100 according to an exemplary embodiment of the present invention is capable of distinguishing living body fingerprint from the artificial one, using the change of color structure in accordance with the change of contact pressure. For example, the living body fingerprint distinguishing apparatus 100 may distinguish living body fingerprint from artificial fingerprint, based on whether or not more than one or two of the conditions of mathematical expressions 2 to 4 are met.

While the term the ‘state of low contact pressure’ may substantively refer to the state where the pressure change starts and the term ‘state of high contact pressure’ may substantively refer to the state where the pressure is close to the maximum, these can be understood as the time of fingerprint contact.

In other words, the ‘state of low contact pressure’ or the ‘state of high contact pressure’ may correspond to two time points (i.e., first and second time points) at which the contact pressure is different. The interval between these two time points may be long enough to check the change of color and can be obtained through experiments. For example, the state of low contact pressure may correspond to the time point when the fingerprint image is input from the color image sensor 135, and the state of high contact pressure may correspond to the time point which is a predetermined time interval away from the time point when the fingerprint image is input from the color image sensor 135.

In the above mathematical expressions, R(1), G(1), and B(1) denote lightness of red, green and blue components at the first time point, and R(2), G(2), and B(2) denote the lightness of red, green and blue component at the second time point.

According to an exemplary embodiment of the present invention, the living body fingerprint distinguishing apparatus 100 may include a pressure sensor or a contact sensor provided in or around the fingerprint input window 110a to check the desired contact pressure.

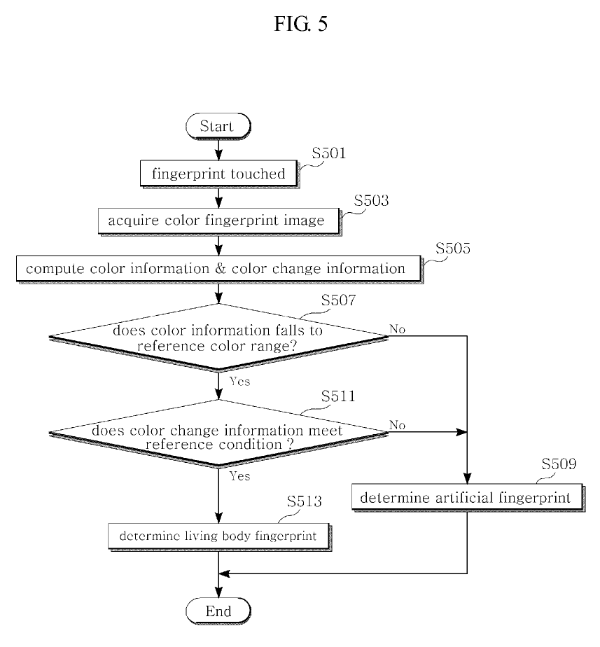

Referring to FIG. 5, the operation of the living body fingerprint distinguishing apparatus 100 according to an exemplary embodiment of the present invention will be explained below. FIG. 5 is a flowchart illustrating a method of determining a living body fingerprint according to an exemplary embodiment of the present invention.

When the fingerprint is brought into contact with the fingerprint input window 110a, the light emitted from the light source 131 is passed through a predetermined light path and converged on the color image sensor 135. Accordingly, at operations S501 and S503, as the fingerprint is contacted with the fingerprint input window 110a, the color image sensor 135 generates a digital color fingerprint image based on the light converged thereon and provides the living body recognition unit 153 with the generated result.

At operation S505, the living body recognition unit 153 computes color information of the ridges of the color fingerprint image received from the color image sensor 135 and information regarding the change of the color (hereinafter, ‘color change information’). In this case, the color information and the color change information may be computed with reference to the entire fingerprint image which corresponds to the size of the color image sensor 135. Alternatively, a selected portion of the fingerprint image may also be used as a reference. The color information may be obtained from the color fingerprint image at certain time point, or based on the average of color information obtained from two or more time points. The color change information may be obtained based on the measurement of the amount of color information changes at the predetermined first and second time points. The states of low and high contact pressures may be used as the first and second time points.

At operation S507, the living body recognition unit 153 first determines whether the fingerprint in question is from the living body or not, based on whether or not the computed color information falls within a reference color range. The reference color range may span from the color of a living body fingerprint which is empirically obtained at a reference time point of acquiring color information to a color added with a predetermined margin or error of the obtained color. FIGS. 2 and 3 show the examples.

At operation S509, if determination at S507 indicates that the computed color information does not match the reference color range, the living body recognition unit 153 determines the fingerprint in question to be artificial one.

At operation S511, if determination at S507 indicates that the computed color information corresponds to the reference color range, the living body recognition unit 153 first determines the fingerprint in question to be a living body fingerprint, and then determines whether or not the computed color change information meets the reference condition. The ‘reference condition’ herein may correspond to at least one of above mathematical expressions 1 to 4. Note that mathematical expressions 1 to 4 are based on the color of ridges, and therefore, changes may be applied if different reference is used.

At operation S513, if determination at S511 indicates that the computed color change information meets the reference condition, the living body recognition unit 153 determines the fingerprint in question to be a living body fingerprint, and if not, determines the fingerprint in question to be an artificial fingerprint.

As explained above, the living body fingerprint distinguishing apparatus 100 according to the exemplary embodiments of the present invention is capable of determining whether the fingerprint contacted with the fingerprint input window 110a is a living body fingerprint or artificial one. The fingerprint recognition unit 151 may proceed to the fingerprint authentication only when the fingerprint is determined to be the living body fingerprint by the determination of the living body recognition unit 153.

As explained above, the living body fingerprint distinguishing apparatus 100 may finish the fingerprint determination without moving to the second determination of S511, or alternatively, may skip the determination at S517 and directly perform determination at S511.

Although the color information and color change information at S515 are based on the average color of the entire color fingerprint image or some of ridges, it will be understood that this is not limiting.

For example, the average color of the ridges and valleys from the entire color fingerprint image or a portion of the color fingerprint image may be used as a reference. In this case, it is considered that the fingerprint image (before inversion) obtained in diffusive manner has darker valleys and subsequently the dark overall image, while the fingerprint image obtained in absorption manner has brighter valleys. After the fingerprint image generated at the color image sensor 135 is inversed, the diffusive type fingerprint image has brighter valleys and the absorption type fingerprint image has darker valleys, and thus the ridges turn from reddish to purplish. Accordingly, the reference color range or reference condition of the color change information is adjusted adequately.

The present invention may be implemented on a method, a device, and a system. If the present invention is implemented on the computer software, the components may be replaced by code segments as required by the operation. The programs or code segments may be stored in a microprocessor processible medium, and may be transmitted in the form of computer data combined with the carrier waves through transmission medium or communication network.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of distinguishing a living body fingerprint, comprising:
irradiating a light toward a prism and acquiring a color fingerprint image of a contacting fingerprint contacted with a fingerprint input window of the prism; and
determining the contacting fingerprint to be the living body fingerprint, if the color fingerprint image has a change of color at a first and second time points, the contacting fingerprint being in contact with the fingerprint input window at the first and second time points.

2. The method of claim 1, wherein the determining comprises:
computing color change information regarding a change of color information of the color fingerprint image at the first and second time points, the contacting fingerprint being in contact with the fingerprint input window at the first and second time points; and
determining the contacting fingerprint to be the living body fingerprint, if the color change information meets a reference condition regarding a change of color of the living body fingerprint which is caused in accordance with a change of a contact pressure.

3. The method of claim 2, wherein one of the first and second time points corresponds to a time point when acquiring of the color fingerprint image begins according to the contact of the fingerprint against the fingerprint input window.

4. The method of claim 2, wherein the reference condition corresponds to at least one of ΔG>ΔR, ΔG>ΔB and R(1)−G(1)>R(2)−G(2), where R(1) and G(2) correspond to lightness of red and green components of the color fingerprint image at the first time point, R(2) and G(2) correspond to lightness of red and green components of the color fingerprint image at the second time point, ΔR=R(2)−R(1), ΔG=G(2)−G(1), and ΔB is a difference of lightness of blue component of the color fingerprint image at the second and first time points.

5. The method of claim 2, wherein the color information includes lightness levels of the red, green and blue components.

6. The method of claim 2, further comprising determining whether or not color information at one time point of the plural time points comprising the first and second time points, or an average of color information at two or more time points of the plural time points comprising the first and second time points, falls to a reference color range, and if not, determining the contacting fingerprint to be artificial fingerprint and omitting the computing of the color change information and the determining the contacting fingerprint to be the living body fingerprint.

7. The method of claim 6, wherein the reference color range spans from a color acquired from the living body fingerprint at one time point of the plural time points comprising the first and second time points to a color added with a predetermined margin of the acquired color, or from an average of colors acquired from the living body fingerprint at two or more time points of the plural time points comprising the first and second time points to a color added with a predetermined margin of the average of colors.

8. The method of claim 2, wherein the color information is based on a ridge area of the color fingerprint image.

9. A method of distinguishing a living body fingerprint comprising:
irradiating a light toward a prism and acquiring a color fingerprint image of a contacting fingerprint contacted with a fingerprint input window of the prism;
computing color information of the acquired color fingerprint image; and
determining whether or not the computed color information falls to a reference color range of the living body fingerprint, and if so, determining the contacting fingerprint to be the living body fingerprint.

10. The method of claim 9, wherein the color information is based on a ridge area of the color fingerprint image.

11. An apparatus for distinguishing a living body fingerprint, comprising:
a light refractor comprising a fingerprint input window with which fingerprint is contacted;
a light source to irradiate light to the light refractor to acquire an image of the fingerprint;
an optical lens system to converge the image output from the light refractor;
a color image sensor to acquire a color fingerprint image from the image converged on the optical lens system; and
a living body recognition unit to compute color change information regarding a change of the color information of the color fingerprint image being acquired at a first and second time points, and determine the fingerprint to be the living body fingerprint when the color change information meets a reference condition regarding the change of color of the living body fingerprint, wherein the fingerprint is in contact with the fingerprint input window at the first and second time points.

12. The apparatus of claim 11, wherein one of the first and second time points corresponds to a time point when acquiring of the color fingerprint image begins according to the contact of the fingerprint against the fingerprint input window.

13. The apparatus of claim 11, wherein the reference condition corresponds to at least one of ΔG>ΔR, ΔG>ΔB and R(1)−G(1)>R(2)−G(2), where R(1) and G(2) correspond to lightness of red and green components of the color fingerprint image at the first time point, R(2) and G(2) correspond to lightness of red and green components of the color fingerprint image at the second time point, ΔR=R(2)−R(1), ΔG=G(2)−G(1), and ΔB is a difference of lightness of blue component of the color fingerprint image at the second and first time points.

14. The apparatus of claim 11, wherein the color information includes lightness levels of the red, green and blue components.

15. The apparatus of claim 11, wherein the living body recognition unit determines whether or not color information at one time point of the plural time points comprising the first and second time points, or an average of color information at two or more time points of the plural time points comprising the first and second time points, falls to a reference color range, and if not, determines the fingerprint to be artificial fingerprint and omits the determining of the living body fingerprint based on the color change information.

16. An apparatus for distinguishing a living body fingerprint, comprising:
an optical refractor comprising a fingerprint input window with which a fingerprint is contacted;
a light source to irradiate light to the optical refractor to acquire an image of the fingerprint;
an optical lens system to converge the image being output from the optical refractor;
a color image sensor to acquire a color fingerprint image from the image converged on the optical lens system; and
a living body recognition unit to compute color information of the color fingerprint image which is acquired by the color image sensor, and determines the fingerprint to be the living body fingerprint if the color information falls to a reference color range of the living body fingerprint.
